(19) United States
(12) Patent Application Publication
(10) Pub. No.: US 2012/0023478 A1
(43) Pub. Date: Jan. 26, 2012

(54) METHOD OF REPLACEMENT FOR A CONTROLLER IN AN ONBOARD POWER SUPPLY SYSTEM IN A VEHICLE

(75) Inventors: Herbert Schäfer, Germering (DE); Marc Witte, Markt Indersdorf (DE)

(73) Assignee: MAN TRUCK & BUS AG, Muenchen (DE)

(21) Appl. No.: 13/189,829

(22) Filed: Jul. 25, 2011

(30) Foreign Application Priority Data
Jul. 24, 2010 (DE) 10 2010 032 136.2

(51) Int. Cl. G06F 9/44

(52) U.S. Cl. 717/107; 717/106

(57) ABSTRACT

A method replaces a controller, particularly a faulty and/or outmoded controller, in an onboard power supply system in a vehicle. The controller to be replaced is replaced by a functional and/or new controller. The controller to be replaced and the new controller are operated by incompatible operating software. In the method at least one software component is exported from a software development environment for the operating software of the controller to be replaced by a data processing apparatus. The software component is converted into a code, which can be imported into a software development environment for the operating software of the functional and/or new controller, by the data processing apparatus. The code is imported into the software development environment of the operating software of the functional and/or new controller by the data processing apparatus. The operating software for the new controller is produced on the basis of the imported code.

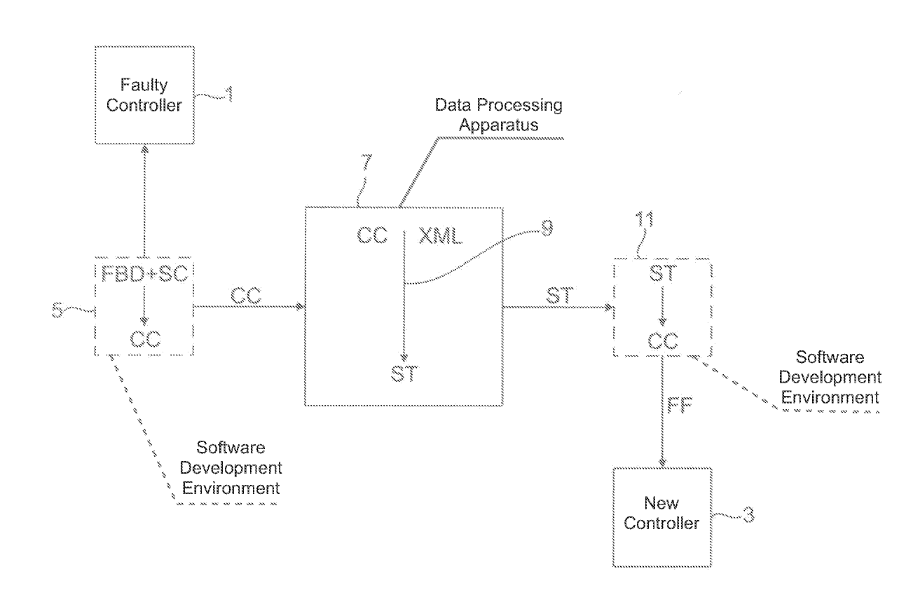

### CROSS-REFERENCE TO RELATED APPLICATION

This application claims the priority, under 35 U.S.C. §119, of German application DE 10 2010 032 136.2, filed Jul. 24, 2010; the prior application is herewith incorporated by reference in its entirety.

### BACKGROUND OF THE INVENTION

### Field of the Invention

The invention relates to a method of replacement for a controller in a vehicle.

The onboard power supply systems in modern motor vehicles have a multiplicity of controllers which are usually connected to one another by a CAN bus. Particularly in the field of commercial vehicles, the signal and message transmission is often effected by what is known as a multiplex system. In a multiplex system, signals are combined and simultaneously transmitted by a medium. In this way, the wiring harnesses in the commercial vehicles can be substantially reduced. The multiplex system may be in the form of a master/slave system which communicates by the CAN bus. In this case, a central controller (onboard power supply system computer) actuates connected multiplex nodes, e.g. input/output nodes, display systems, etc.

If the central controller is faulty or outmoded, it needs to be replaced by a new controller. In this context, what is meant by a new controller is, by way of example, a functional controller which can undertake the function of the faulty controller. In addition, original equipment manufacturers are obliged to provide spare parts for a certain period. In practice, this situation regularly results in problems when central controllers need to be replaced. For example, the operating software of old onboard power supply system computers is often not compatible, i.e. incompatible, with the operating software of onboard power supply system computers from a new generation. It is therefore no longer possible to replace the onboard power supply system computer without substantial involvement in terms of work and cost.

### SUMMARY OF THE INVENTION

It is accordingly an object of the invention to provide a method of replacement for a controller in an onboard power supply system which overcomes the above-mentioned disadvantages of the prior art methods of this general type, which allows a controller, particularly a faulty or outmoded controller, in the onboard power supply system of a vehicle to be replaced easily, quickly and in functionally reliable fashion by a functional and/or new controller in spite of operating software which is not compatible (incompatible).

In accordance the invention, a method replaces a controller, particularly for a faulty and/or outmoded controller, in an onboard power supply system in a vehicle. In which method of replacement the controller to be replaced is replaced by a functional and/or new controller, wherein the controller to be replaced and the functional and/or new controller are operated by incompatible (not compatible with one another) operating software. In the method at least one software component is exported from a software development environment for the operating software of the controller to be replaced by a data processing apparatus. The at least one software component is converted into a code, which can be imported into a software development environment for the operating software of the new controller, by the data processing apparatus. The code is imported into the software development environment of the operating software of the functional and/or new controller by the data processing apparatus. The operating software for the functional and/or new controller is produced on the basis of the imported code by the data processing apparatus.

This allows faulty or old controllers to be replaced by functional and/or new controllers from a new generation in spite of software incompatibility. Provision of spare parts for the controllers can therefore be assured without a high level of involvement.

In one specific embodiment, the controller to be replaced may contain a central controller, particularly an onboard power supply system computer, of a vehicle, particularly of a motor vehicle or commercial vehicle. Particularly when onboard power supply system computers are replaced, problems arise in respect of software compatibility which are able to be rectified using the described method of replacement.

Preferably, the controller to be replaced may be connected in a multiplex system, particularly a master/slave system. In this case, the controller to be replaced may be connected as a master and can actuate at least one multiplex node. Multiplex systems of this kind are used particularly in modern commercial vehicles. The operating software of such controllers is of relatively complex design, which means that the use of the described method of replacement is advantageous particularly for these appliances.

With particular preference, the controller to be replaced may be connected in a CAN bus system. CAN bus systems require complex operating software for networking the controllers. The method described is therefore particularly suitable for replacing such controllers.

In one specific embodiment, the at least one software component can be exported from the software development environment of the operating software of the controller to be replaced as C code by the data processing apparatus. In comparison with the interpretation of other code types, the interpretation of C code is relatively simple. C code can therefore also be used to interpret the software of old controllers.

Preferably, the at least one software component from the software development environment of the operating software of the controller to be replaced may contain at least one function block diagram and/or at least one flow controller.

With particular preference, the importable code can be produced by compiling by use of a cross compiler in the data processing apparatus. The cross compiler can produce compilations for the functional and/or new controller, even though the operating software thereof is incompatible with the operating software of the controller which is to be replaced. It is therefore also possible to use software components from the software development environment of the operating software of the controller to be replaced for the functional and/or new controller.

Advantageously, the importable code can be produced by compiling the C code into a structured text. Structured text can be imported into the software development environment of the functional and/or new controller comparatively easily.

In particular, the C code can be compiled into structured text on the basis of at least one XML file as a machine-readable reference. A description parser can read in the at least one XML file, which serves as a reference for compiling the C code into structured text. Furthermore, a basic parser can analyze the structure of the C code and a lex parser may be responsible for the actual conversion of the C code into structured text.

With particular preference, the operating software for the functional and/or new controller can be produced as a flash file by the data processing apparatus. Flash files advantageously have a relatively small data volume.

The method described above can be carried out either manually or fully automatically.

Other features which are considered as characteristic for the invention are set forth in the appended claims.

Although the invention is illustrated and described herein as embodied in a method of replacement for a controller in an onboard power supply system in a vehicle, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

An exemplary embodiment of the invention is described below with reference to the appended FIGURE. The exemplary embodiment described should be understood as purely exemplary and in no way limiting.

### BRIEF DESCRIPTION OF THE DRAWING

The single FIGURE of the drawing is a basic illustration of an inventive method of replacement for a controller in an onboard power supply system in a vehicle according to the invention.

### DETAILED DESCRIPTION OF THE INVENTION

Referring now to the single FIGURE of the drawing in detail, there is shown a grossly schematic illustration of a method of replacement in which a faulty controller 1 is replaced with a functional or new controller 3. The controllers 1, 3 are used as a central onboard power supply system computer for a vehicle, particularly a motor vehicle or commercial vehicle, for example, which is not shown in the present case. On account of their different production generations, the controller 1 to be replaced and the new controller 3 are operated by operating software which are not compatible.

The method of replacement first of all involves software components being exported from the software development environment 5 of the operating software of the controller 1 to be replaced by a data processing apparatus 7. The software components contain function block diagrams FBD and flow controllers SC, also called sequencers, which are converted into an exportable C code CC in the software development environment 5 of the operating software of the controller 1 to be replaced.

When the C code CC has been exported, it is converted into a structured text ST by the data processing apparatus 7 as a result of compiling by the cross compiler 9. In this case, an XML file XML is a machine-readable reference between the C code CC and the structured text ST.

A description parser reads in the XML file XML and creates a dynamic structure which in turn contains the necessary information in order to convert the C code CC into structured text ST. A basic parser analyzes the structure of the C code CC, while a lex parser is responsible for the actual conversion of the C code CC into structured text ST.

Configurations which cannot be covered by the structured text ST can be imported into the software development environment 11 of the operating software of the new controller 3 by a further import (for example XML import). The software can be imported into the new controller 3 either manually or fully automatically.

The structured text ST is in turn converted in a software development environment 11 of the operating software of the new controller 3 into a C code CC, on the basis of which a flash file FF is produced. Finally, the flash file FF is imported into the new controller 3. The controller 1 to be replaced is then replaced with the new controller 3 in a replacement step, which is not shown in the present case.

1. A method of replacing a controller, including a faulty controller or an outmoded controller, in an onboard power supply system in a vehicle, in which method of replacement the controller to be replaced is replaced by a new controller, the controller to be replaced and the new controller are operated by incompatible operating software, which comprises the steps of:
exporting at least one software component from a software development environment for an operating software of the controller to be replaced by means of a data processing apparatus;
converting the at least one software component into a code, which can be imported into a software development environment for the operating software of the new controller, by means of the data processing apparatus;
importing the code into the software development environment of an operating software of the new controller by means of the data processing apparatus; and
producing the operating software for the new controller on a basis of a the code imported by means of the data processing apparatus.

2. The method of replacement according to claim 1, wherein the controller to be replaced is a central controller of a vehicle.

3. The method of replacement according to claim 1, wherein the controller to be replaced is connected in a multiplex system being a master/slave system.

4. The method of replacement according to claim 3, wherein the controller to be replaced is connected as a master and actuates at least one multiplex node.

5. The method of replacement according to claim 1, wherein the controller to be replaced is connected in a CAN bus system.

6. The method of replacement according to claim 1, which further comprises producing the operating software for the new controller as a flash file by means of the data processing apparatus.

7. The method of replacement according to claim 1, which further comprises exporting the at least one software component from the software development environment of the operating software of the controller to be replaced as C code by means of the data processing apparatus.

8. The method of replacement according to claim 1, wherein the at least one software component from the software development environment of the operating software of the controller to be replaced contains at least one function block diagram and/or at least one flow controller.

9. The method of replacement according to claim 1, which further comprises producing the code imported by compiling by means of a cross compiler in the data processing apparatus.

10. The method of replacement according to claim 7, which further comprises producing the code imported by compiling the C code into a structured text.

11. The method of replacement according to claim 10, which further comprises compiling the C code into the structured text on a basis of an XML file as a machine-readable reference.

12. The method of replacement according to claim 1, wherein the controller to be replaced is an onboard power supply system computer of a motor vehicle or a commercial vehicle.
